(19) United States
(12) Patent Application Publication
(10) Pub. No.: US 2007/0042327 A1
(43) Pub. Date: Feb. 22, 2007

(54) Determination of scaling for scaled physical architectural models

(76) Inventor: Lawrence W. Swift, Potomac, MD (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/485,084

(22) Filed: Jul. 12, 2006

Related U.S. Application Data
(60) Provisional application No. 60/709,938, filed on Aug. 19, 2005.

(51) Int. Cl. G09B 25/00

(52) U.S. Cl. 434/72

(57) ABSTRACT

A method for defining the scale of an architectural model that is a building model integrated with a site model. The method includes selecting a standard sized modeling board or stock from which the site model is to be built. The method further comprises determining the length (x), width (y), and height (z) of the plat corresponding to the land to be modeled by the site model, as well as the x:y:z ratio of the plat. Dimensions for the site model are then determined. The site model dimensions fit within the dimensions of the standard sized stock and maintain the original x:y:z ratio of the plat. The scale of the architectural model is then determined by dividing the dimensions of the site model by the dimensions of the plat.

### CROSS REFERENCE TO RELATED APPLICATIONS

This application claims priority benefit under 35 U.S.C. §119(e) from provisional application No. 60/709,938, filed Aug. 19, 2005. The 60/709,938 application is incorporated by reference herein, in its entirety, for all purposes.

This application also relates to co-pending applications by the same inventor of this application and entitled “Building of Scaled Physical Models” (application Ser. No. ______, filed ______), “Identification of Terrestrial Foliage Location, Type, and Height for Architectural Models” (application Ser. No. ______, filed ______), and “Applying Foliage and Terrain Features to Architectural Scaled Models” (application Ser. No. ______, filed ______).

### FIELD OF THE INVENTION

The invention relates generally to architectural processes of building physical models to develop and communicate building design concepts. In particular, the invention relates to a method for defining the scale of an architectural model in a manner which allows use of a standard sized modeling board.

### BACKGROUND OF THE INVENTION

The codification of an architect's design concept traditionally has been with the hand drafting of “blue prints” type drawings. As part of the architectural design process, scaled physical models have often been built (either in-house at the architect's offices or outsourced to a model builder) in order to ensure that a client fully understands the architect's or designer's concept. The scale of each model built has generally been determined primarily by starting with the measurements of the building and scaling the model back from that full-scale design. Examples of typical scaling ratios are:
one foot (1′)) of actual building size=one quarter inch (¼″) of model size;
one foot (1′)) of actual building size=one sixteenth inch ( 1/16″) of model size;
one foot (1′)) of actual building size=one eighth inch (⅛″) of model size;
thirty-two feet (32′)) of actual building size=one inch (1″) of model size; and
fifty feet (50′)) of actual building size=one inch (1″) of model size.

Referring to FIG. 1, once the scale has been chosen for the building model, the site model's (a scaled model of the building site terrain upon which the building model sits) scale is accordingly set to be the same. On occasion, for topographical physical models, the scale of the model is based on the terrain, with the scaling coming from some fraction of the terrain's actual dimensions. In either case, the scale is based on starting with the larger (building full scale design or the property's dimension) and scaling back to the smaller (building model scale or site model scale).

Traditionally, the selection of building scale has been a decision made by the architect or designer based on what he/she wanted the end model to look like.

With the advent of computer aided design (CAD) software tools into the architect community, architects and designers have begun to use computer software programs to design buildings, replacing the traditional hand-drawn approach. Originally, these architectural CAD tools were two dimensional (2D) tools that simply brought the hand drafting process onto the computers.

### SUMMARY OF THE INVENTION

Recently, the architectural industry has begun to adopt three dimensional (3D) CAD tools to perform architectural design work. The availability of this 3D data has created an opportunity for efficient production of scaled physical models directly from the architect's or designer's 3D CAD data using rapid prototyping (3D Printing) and/or CNC machining technologies. Such an approach to architectural modeling is disclosed in co-pending application claiming priority from provisional application No. 60/698,706 and entitled “Building of Scaled Physical Models” (application Ser. No. ______, filed ______), which is incorporated by reference herein for all purposes.

The present invention may be embodied variously as a method for determining the scale of an architectural model according to a standardized set of end result sizes. The method includes selecting a standard sized modeling board or stock from which the site model portion of the architectural model is to be built. The method also includes making a determination of the length (x), width (y), and height (z) of the plat or property upon which the structure the architect has designed is intended to be built. The dimensions of the site model are determined according to the dimensions of the selected standard sized stock and the original x:y:z ratio of the model. The site model dimensions need to fit within the dimensions of the standardized stock while maintaining the original x:y:z ratio of the plat. The scale of the architectural building model is then determined by dividing the dimensions of the site model by the dimensions of the plat.

One aspect of this invention is a process for determining the scale of an architectural scaled model based on maximizing the efficiency of an automated model manufacturing process.

It is therefore an aspect of the present invention to automate the process of determining the scale of an architectural model.

It is another aspect of the present invention to define the scale of an architectural model in a manner which allows use of a standard sized stock for the site model portion of the architectural model.

It is yet another aspect of the present invention to simplify the production, storage, and shipment of stock used for production of architectural models by limiting the assortment of dimensions of stock.

It is another aspect of the present invention to maximize the efficiency of the automated model manufacturing process.

One embodiment of the present invention is a method for determining the scale of an architectural model. The method has a step of selecting, from among plural predetermined sizes of stock, a stock size from which a site model portion of the architectural model is to be built. Once the stock size is selected, an x:y:z ratio of a plat is determined that corresponds to a site to be modeled by the site model. The x:y:z dimensions for the site model are selected as having the same x:y:z ratio as the plat and fitting within the dimensions of the selected stock size. The scale of the architectural model (both the site model portion and the building model portion) is determined by dividing the selected x:y:z dimensions of the site model by the dimensions of the plat. Then both the site model is fabricated according to the determined scale, and a building model is fabricated according to the same determined scale. The architectural model is formed by integrating the building model with the site model.

Another embodiment of the present invention is a method for manufacturing a scaled architectural model having both a site model portion and a building model portion. The method includes storing electronic architectural design data in a building model file, and modifying the building model file to ensure compliance with manufacturing requirements of additive manufacturing equipment, thereby producing a conforming building model file. The method further includes storing electronic site contour data in a site model file and selecting, from among plural predetermined sizes of stock, a stock size from which a site model portion of the scaled architectural model is to be built. An x:y:z ratio of a plat represented by the site model file is determined, and x:y:z dimensions for the site model file: are selected having the same x:y:z ratio as the plat and fitting within the dimensions of the selected stock size. The site model file is modified to ensure compliance with manufacturing requirements of subtractive manufacturing equipment, thereby producing a conforming site model file. The scale of the site model is determined by dividing the selected x:y:z dimensions of the site model file by the dimensions of the plat, and the conforming building model file is modified to have the same scale as the site model file. The conforming building model file is transmitted to the additive manufacturing equipment to produce a building model. The conforming site model file is transmitted to the subtractive manufacturing equipment to produce the site model. Once produced, the building model and the site model are integrated.

### BRIEF DESCRIPTION OF THE DRAWINGS

FIG. 1 illustrates a conceptual diagram of the conventional process for deciding scale of a model.

FIG. 2 illustrates a conceptual diagram of a process for deciding scale according to an embodiment of the present invention.

FIG. 3 illustrates side and top view comparisons of a stock material work piece and site data corresponding to the plat of the property of interest.

FIG. 4 illustrates a comparison of various possible orientations of the plat with respect to the stock.

FIG. 5 illustrates a comparison of various possible positions of the plat with respect to the stock at various orientations.

FIG. 6 illustrates a comparison of various possible sizing changes of the plat with respect to the stock at various orientations.

FIG. 7 illustrates a flowchart of a process for making architectural models according to an embodiment of the invention.

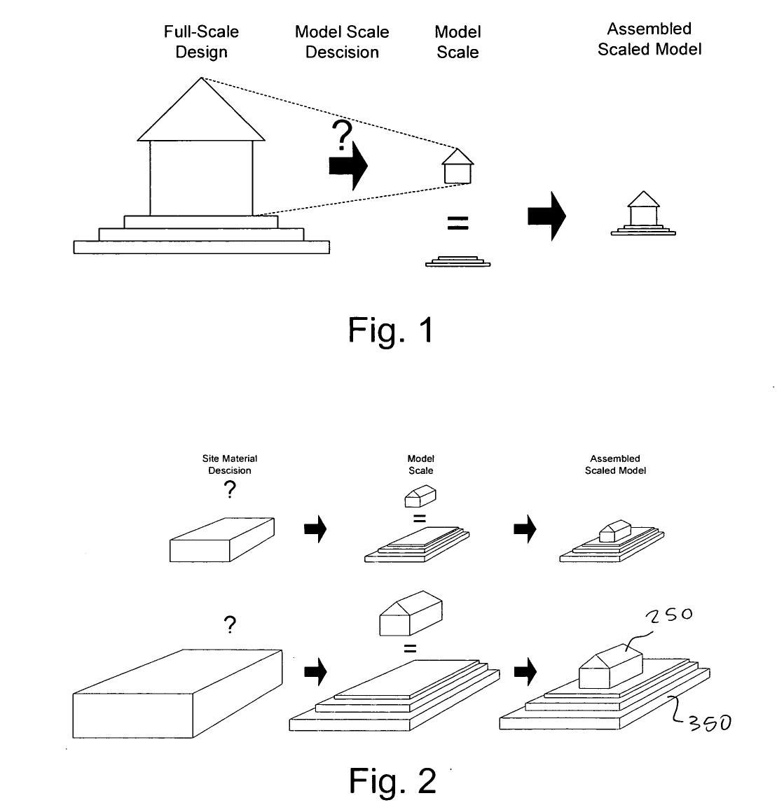

### DETAILED DESCRIPTION

The present invention brings together disparate technologies from the fields of rapid industrial prototyping, machine tool manufacturing and airborne and/or satellite imagery to establish a new approach to building architectural physical models. Although the invention draws on technology from each of these disparate arts, the invention itself is most closely related to the art of architectural development tools.

Rapid prototyping is the automated construction of physical objects using solid freeform fabrication. The first techniques for rapid prototyping became available in the 1980's. Today, there is a wide range of rapid prototyping techniques that are used for a wide range of applications including to manufacture production quality parts in relatively small numbers. Some sculptors use the technology to produce complex shapes for fine art exhibitions. The major rapid prototyping techniques currently available include:
Fused deposition modeling: This technique extrudes hot plastic through a nozzle to building up a part.
Laminated object manufacturing: According to this technique, sheets of paper or plastic film are attached to previous layers by either sprayed glue, heating, or embedded adhesive, and then the desired outline of the layer is cut by laser or knife. The finished product typically looks and acts like wood.
Selective laser sintering (SLS): SLS uses a laser to fuse binder-coated metals, powdered thermoplastics, or other materials.
Stereolithography: This technique uses a laser to photocure liquid polymers.
Powder-binder printing: For this technique, layers of a fine powder are selectively bonded by “printing” a water-based adhesive from an inkjet print head. This includes both thermal phase change inkjet and photopolymer phase change inkjet.

In brief, rapid prototyping takes virtual designs (from computer aided design (CAD) software or from animation modeling software), transforms them into cross sections, still virtual, and then creates each cross section in physical space, one after the next until the model is finished. The virtual model and the physical model correspond almost identically.

In additive fabrication rapid prototyping, a machine reads in data from a CAD drawing, and lays down successive layers of liquid or powdered material, and in this way builds up the model from a long succession of cross sections. These layered cross sections which correspond to the virtual cross sections from the CAD model are fixed together (glued or fused automatically, often using a laser) to create the final shape. The primary advantage to additive construction is its ability to create almost any geometry, with the notable exception of trapped negative volumes.

The standard interface between CAD software and rapid prototyping machines is the .STL file format.

Computer Numerical Control (CNC) refers specifically to the computer “controller” that reads programming code (any of, e.g., G-code, M-codes, DNC conversational, or APT code) instructions and drives an associated machine tool. The introduction of CNC machines radically changed the manufacturing industry, and as the number of machining steps that required human action has been dramatically reduced. When a machine tool is controlled by a CNC, curves are as easy to cut as straight lines, complex three dimensional structures are relatively easy to produce, and consistency and quality are improved because the frequency of errors is reduced.

CNC machines today are controlled directly from files created by CAD/CAM (Computer Aided Manufacturing) software packages, so that a part or assembly can go directly from design to manufacturing without the need of producing a drafted paper drawing of the manufactured component. In a sense, the CNC machines represent a special segment of industrial robot systems, as they are programmable to perform many kinds of machining operations (within their designed physical limits) like other robotic systems.

One standard interface between CAM software and CNC machines is G-Code instruction files.

One embodiment of the present invention is a process for determining the scale of the site model portion (or base) of an architectural scaled physical model so as to maximize the efficiency of automated model manufacturing processes. The architectural model has both a building model portion and the site model portion, with the building model (a model of the building according to an intended design) sitting atop the site model (a model of the land the building is to occupy). The process of this embodiment (refer to FIG. 2) focuses on standardizing the model's scale decision based on the selection of the material from which the Site Model is fabricated.

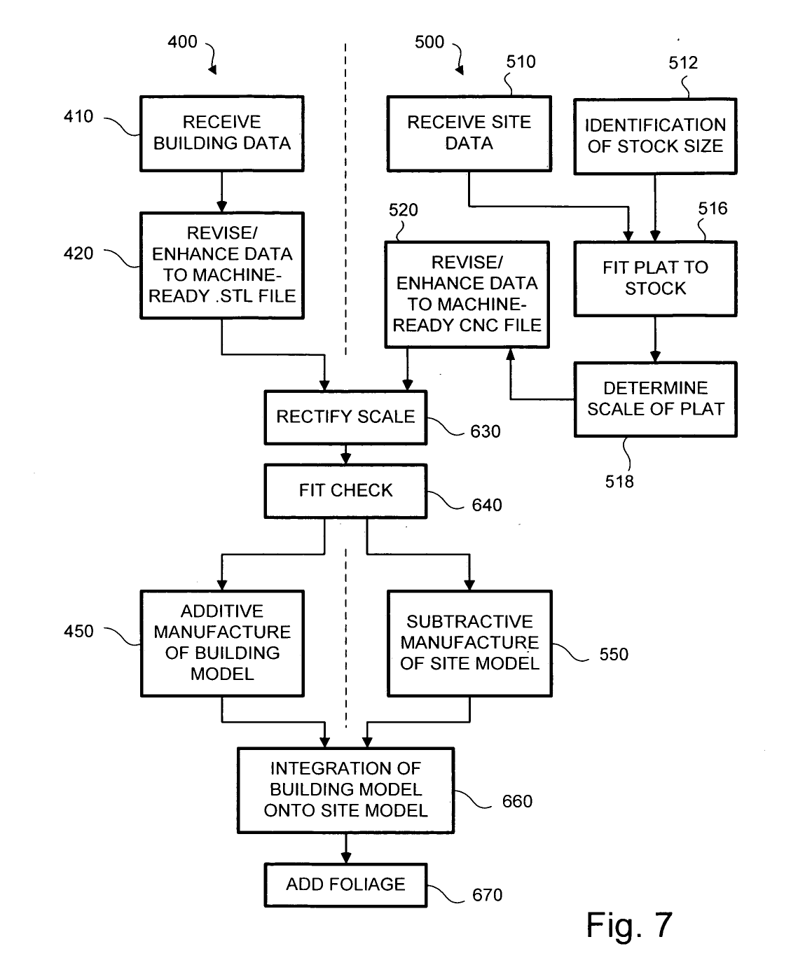

Referring to FIG. 7, the architect or a model maker initially chooses 512 from standardized block material from which the site model is to be fabricated. Once the material size is chosen, the site model is “fitted” 516 to the chosen material, and it is in this fitting that the scale of the model is established.

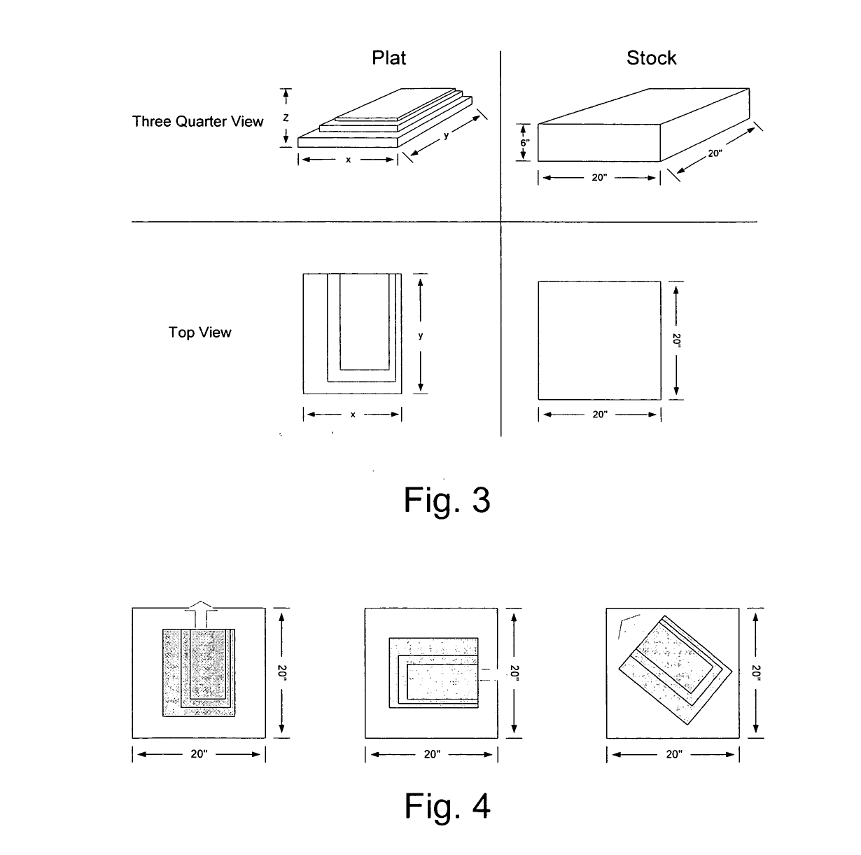

The topography of the property upon which the architect intends to build a structure is typically archived by the state and or county, and is often documented by a “plat.” From this plat, the length (x variable), width (y variable) and height (z variable) of the property can be established. In the exemplary situation where an architect chooses to outsource the building of an architectural scaled model (which integrates both a building model and a site model) by a model manufacturing company (model builder). This model builder manufactures the site model from polyurethane modeling boards. These are solid planks made of polyurethane plastic, which can be machined with milling machines or routers controlled by computer numerical controlled (CNC) technology. Other materials can also be used. For purposes of this example, the model builder maintains an inventory of standard-sized polyurethane boards in two sizes: 20″×20″×6″ and 15″×15″×6″. The architect chooses whether the site model shall be machined from the 20″×20″×6″ stock or the 15″×15″×6″ stock. For further purposes of this example, the 20″×20″×6″ stock is chosen. Both the stock material and the property's plat are shown in FIG. 3.

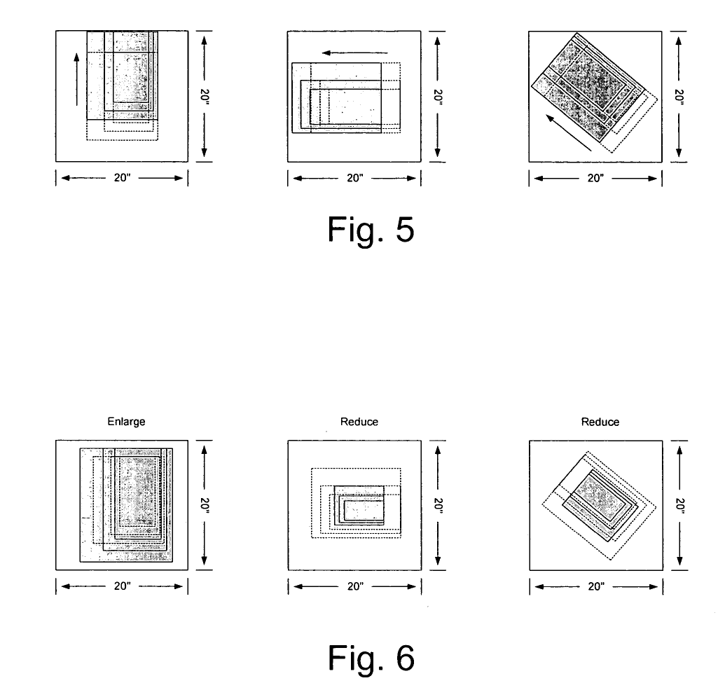

Once the stock size is determined 512, then the site model is “fitted” 516 to the stock in such a way that:
the x, y, and z dimension relationship of the plat is maintained in ratio;
the orientation of the plat on the stock (refer to FIG. 4) is determined;
the position of the plat on the stock (refer to FIG. 5) is determined; and
the scale of the plat on the stock (refer to FIG. 6) is defined.

Various possible orientations of the plat positioned within the dimensions of the stock are portrayed in FIG. 4. Various possible positions of the plat positioned within the dimensions of the stock are portrayed in FIG. 5. Various possible scaled dimensions of the plat relative to the stock are portrayed in FIG. 6.

Fitting of the site model within the stock can be performed 516 in a commercially available software program that allows for the visualization and scaling of objects, such as Rhino, FormZ, AutoCAD, or SolidWorks. It should be understood, however, that the invention is not limited to use of these commercial products and may use other means to perform fitting. Alternatively, fitting of the site model within the stock can be performed on paper and later converted to a 3D CAD file. As another alternative, network enabled software such as that disclosed by the same inventor as this application in the related application entitled “Building of Scaled Physical Models” (application Ser. No. ______, filed ______, and which claims priority from provisional application No. 60/698,706.

Referring further to FIG. 7, a flowchart for a process by which architectural electronic design data can be used to build scaled physical models is illustrated. The process has a process flow 400 for making the building model, which is mostly separate from a process flow 500 for making the site model. The building model process flow 400 and the site model process flow 500 are conceptually parallel to one another and may be executed substantially contemporaneously with one another.

The building model process flow 400 begins the reception 410 of building model data from an architect or designer. The format the building model data is received in is any format known to those skilled in the art so long as it can be transformed or translated into a format that is compatible with CAD software. For example paper format blueprints can be scanned and captured to be placed into an electronic form. Non-3D CAD formats are translated into a 3D CAD format either by conversion or design translation. Thus, 2D CAD files, 3D CAD files, and .stl files can all be received into and utilized for a process according to this invention. For ease of description, the process as described below will presuppose that the building model data has been either delivered in, or has been converted into, the standard stereolithography output format which is known in the CAD art and for which the files have the file extension “.stl” (a standard output format for almost all 3D CAD software programs).

A building model .stl file received from the architect contains a complete description of the building model design, and is output from the architect's 3D CAD software package. Once received, the .stl file is examined to ensure suitability for manufacturing in additive manufacturing equipment, which is commonly referred to as “rapid prototyping” equipment. Three dimensional printers are additive manufacturing machines suitable for implementing the invention, and are commercially available as products manufactured by Z Corp, Stratasys, and 3D Systems.

A search of the data file is conducted for anomalies that would prevent successful manufacturing of the building model “part.” Any such anomalies identified are modified or repaired 420 so that manufacture of the model can be accomplished. Examples of repairs that are typically effected include making parts be “water tight” (i.e., no gaps, holes or voids in the model), and insuring that no features are below minimal manufacturing tolerances. Commercially available software programs are available for this purpose, such as Materialise's Magics, or proprietary analysis software may be used. Additional changes to the electronic model (e.g., changing the size of railings or fence posts) may be useful and can be accomplished with the use of 3D CAD programs. Examples of 3D CAD programs that can be successfully used to do this are Rhino, FormZ, AutoCAD, and SolidWorks. As an alternative, .stl manipulation programs (such as Magics) can be used to make the changes to revise the building model data file.

Once the fitting of the plat within the stock is complete, the scale is determined 518 by dividing the scaled plat (as fitted to the stock) by the full-scale (1:1) plat. This calculation provides the scale ratio of the site model. Once the building model .stl file is determined to be suitable for manufacturing, the same scale ratio as for the site model is applied 630 to the full-scale building design dimensions will provide the scale of the building model. Most all 3D CAD software programs (e.g., Rhino, FormZ, AutoCAD, SolidWorks) can easily scale designs based on operator-defined ratios. Additionally, a fit check 640 is made to ensure that the building model can be attached to the site model.

Once the scales are rectified 630 and if both the fit check 640 is met, the building model .stl file is submitted 450 to the additive manufacturing equipment to be built. The process this equipment performs is referred to as an “additive” process, since the part (in this case the building model) is typically built up one layer at a time by the rapid prototyping manufacturing equipment. Various types of media (e.g., plastic or plaster) can be used by the equipment to make the building models, and the media may be colored depending on the manufacturer and rapid prototype equipment selected.

Various post processing efforts are performed, depending on the additive manufacturing equipment selected. For example, when using a Z510 model three dimensional printer manufactured by Z Corp., once the building model is built up and has had suitable time to dry, the part is excavated from the Z510 machine and “de-powdered” to remove all excess material. The de-powdering is done because the Z510 uses a plaster-like powder material as its medium to build the parts it makes. The de-powdered building model can then be “infiltrated” with any of a variety of waxes, urethanes, or resins, depending on the desired surface characteristics for the building model. Once infiltrated, the building model may be hand finished as necessary to ensure the desired look, quality and finish.

After the post processing efforts have been completed, the fabricated building model 250 is ready to be attached 660 to the site model 350 (refer to FIG. 2).

The site model process flow 500 (refer to FIG. 7) can be performed in parallel to the building model process flow 400 to minimize overall process completion time.

The site model process flow 500 begins with the reception 510 of site model data from the architect, designer, or survey engineer. The site model data can be in various formats. Either paper format (e.g., plats) or electronic format (e.g., 2D CAD files, 3D CAD files, .stl files, etc.) can be utilized in the process. In order to-be manufactured, non-3D formats must be translated into 3D formats, either by conversion or design translation. For ease of description, the process as described below will presuppose that the site model data has been either delivered in, or has been converted into, the standard stereolithography output format which is known in the CAD art and for which the files have the file extension “.stl”. Once ready, the .stl file is fitted (i.e., sized and oriented) 516 with respect to the chosen stock size.

Once fitted 516 to the chosen stock, the .stl file is converted 520 into a programming language (e.g., G-Code) that is used by subtractive manufacturing equipment, such as a CNC machine tool (e.g., a CNC milling machine or a CNC routing machine). This conversion can be done with off-the-shelf CAM (Computer Aided Manufacturing) software programs such as ArtCAM by Delcam plc (www.artcam.com).

This manufacturing equipment is described as performing a “subtractive” process in that the part (in this case the site model) is created by taking material away from a block of material with milling or routing machinery. The site models can be made from various types of material, such as plastic modeling boards, Styrofoam, Medium Density Fiberboard or blocks of wood.

When the subtractive manufacturing equipment completes formation of the site model, it can then be hand finished as necessary to ensure the desired look, quality, and finish, after which the site model 350 is ready to be physically integrated 660 with the building model 250 (refer to FIG. 2).

In order to handle foliage modeling, either a foliage survey or landscaping plan of the property can be used or, an aerial and/or satellite imagery of the site model property may be obtained to perform digital image classification of the type of vegetation and the vegetations' location on the site. Examples of data sources for aerial and/or satellite imagery can be found on commercial web sites such as http://earth.google.com/, http://www.terraserver.com, and http://www.airphotousa.com, as well as web sites of government agencies responsible for agriculture or mapping, such as http://geography.usgs.gov/partners/viewonline.html. Other public and private sources for such data are also available. When used in the present invention, the satellite and/or aerial imagery data may be geo-referenced. Digital sources of imagery data (either satellite or aerial) are preferred, particularly those having a resolution of about 1 meter per pixel or less, those that are in color, and those that are taken with LIDAR (LIght Detection And Ranging) technology, although this is not meant as a limitation. The better the image quality is, the better it will provide meaningfully enhanced quality of foliage analysis.

Identification of foliage type and location is preferably conducted via one or more processes as disclosed in co-pending application Ser. No. ______ (filed ______), which claims priority from provisional patent application No. 60/698,707, is entitled “Identification of Terrestrial Foliage Location, Type, and Height for Architectural Models,” and which is hereby incorporated by reference into this application for all purposes. Identification of foliage type and location is satisfactorily performed using commercially available software. Algorithms for the identification of foliage from satellite and/or airborne images have been developed by Pollock (1994), Gougeon (1995), Brandtberg and Walter (1999), Wulder et al. (2000), and McCombs et al. (2003). In general, these algorithms perform digital image classification using the spectral information from the digital and/or airborne satellite imagery, and classify each individual pixel based on spectral information. This type of classification is generally termed “spectral pattern recognition.” The objective is to assign all pixels in the image to particular classes or themes (i.e. coniferous forest, deciduous forest, etc.). Commercial software packages that provide some functionality of this type include eCognition Forester by Definiens and Feature Analyst® by Visual Learning Systems.

As an alternative, or as a supplement, to software as described above, direct personal observations of the foliage may be used to model the type, height, and location. Such direct data gathering is labor intensive, and thus usually disfavored, but may be a useful substitute or adjunct when readily available image data for the site is deficient or lacking. Such information would subsequently be entered into a data file in the present invention for later manipulation. As an alternative, a landscape plan identifying location, type and size of foliage may be used.

Information identified by software (or through direct observation if need be) includes (1) identification of all the significant vegetation on the site, (2) the longitude and latitude location of each vegetation identified, (3) the type of each identified vegetation (i.e. evergreen, deciduous, shrub), and (4) the estimated height of each item of vegetation identified. This information is then integrated into the architect's site model to provide vegetation placement points in the site model.

At the ends of the building model process flow 400 and the site model process flow 500, these two process flows join together in a model integration process 660. Once the building model and site model are complete, these elements of the architectural model are integrated together. This integration involves attaching the building model to the site model and then securing 670 any foliage (i.e. trees and shrubs) to the site model 350. Integration may also include a step of painting the landscape on the site and other finishing techniques.

Additional elements can be added to the integrated Model such as a wood-framed base and/or a glass or Plexiglas dust cover as appropriate to provide support and protection.

Finally, a quality inspection is performed to ensure the architectural model meets all specified standards and requirements.

The approach described above for determining the scale of models has many benefits. Some of the benefits of the present invention are listed as follows.

One benefit of the present invention is that fewer inventory items are kept on hand. By standardizing the manufacturing stock to a limited number of choices, fewer sizes of stock need to be inventoried which increases inventory turns (financial term that translates into reducing the cost of holding inventory), reduces the amount of inventory space required, increases purchasing economies of scale with stock vendors, and simplifies supply chain issues.

Another benefit of the present invention is standardized manufacturing processes. By limiting the number of stock sizes available, the tooling set-up and machining issues associated with processing stock in milling machines or routers is simplified, reducing the amount of labor-necessary to process the stock and shortening the overall processing time.

Yet another benefit of the present invention is standardization of add-on optional items. Optional items that are added to the models also become standardized with the standardization of the stock. As an example, an option could be a glass/plastic box (“dust cover”) that covers and protects the architectural model. By standardizing the stock, the x and y dimensions of the cover also become standardized. This greatly simplifies the ability of the model builder to quickly supply its clients with such optional items by eliminating the customization of such optional items. This will also reduce costs for reasons of reduced inventory as discussed above.

A further benefit of the present invention is simplification and improvement of shipping containers. By standardizing the stock, the need to customize shipping materials (i.e., cardboard boxes with protective inserts) is eliminated. This reduces the amount of time necessary to ship models and improves the shipping survivability of models since standard shipping materials can be designed (once the model size has been standardized) that are optimized for the standardized stock.

The benefits described above are only examples and are not intended to be an exhaustive list of benefits. In summary, the present invention changes the traditional scaling decision approach (defining the scale of a model by starting with the,. full-scale design and dimensioning downward to a targeted model size) to a more efficient approach that starts with deciding upon the stock size, then fitting the plat to the stock, and then dimensioning the building model from the ratio for the fitted site model.

A method for the determination of scaling for scaled physical models for the architectural industry has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, or instantiation is in all respects illustrative and not limiting.

What is claimed is:

1. A method for determining the scale of an architectural model and building the architectural model to that scale, the method comprising:
selecting, from among plural predetermined sizes of stock, a stock size from which a site model portion of the architectural model is to be built;
determining an x:y:z ratio of a plat that corresponds to a site to be modeled by the site model;
selecting x:y:z dimensions for the site model having the same x:y:z ratio as the plat and fitting within the dimensions of the selected stock size;
determining the scale of the architectural model by dividing the selected x:y:z dimensions of the site model by the dimensions of the plat;
fabricating the site model according to the determined scale;
fabricating a building model portion of the architectural model according to the determined scale; and
forming the architectural model by integrating the building model with the site model.

2. A method for manufacturing a scaled architectural model, the method comprising:
storing electronic architectural design data in a building model file;
modifying the building model file to ensure compliance with manufacturing requirements of additive manufacturing equipment, thereby producing a conforming building model file;
storing electronic site contour data in a site model file;
selecting, from among plural predetermined sizes of stock, a stock size from which a site model portion of the scaled architectural model is to be built;
determining an x:y:z ratio of a plat represented by the site model file;
selecting x:y:z dimensions for the site model file having the same x:y:z ratio as the plat and fitting within the dimensions of the selected stock size;
modifying the site model file to ensure compliance with manufacturing requirements of subtractive manufacturing equipment, thereby producing a conforming site model file;
determining the scale of the site model by dividing the selected x:y:z dimensions of the site model file by the dimensions of the plat;
modifying the conforming building model file to have the same scale as the site model file;
transmitting the conforming building model file to the additive manufacturing equipment to produce a building model;
transmitting the conforming site model file to the subtractive manufacturing equipment to produce the site model; and
integrating the building model with the site model.

3. The method of claim 2, further comprising:
checking that the conforming building model file can fit onto the conforming site model file.

4. The method of claim 2, wherein the additive manufacturing equipment comprises rapid prototyping manufacturing equipment.

5. The method of claim 2, wherein the additive manufacturing equipment comprises a three dimensional printer.

6. The method of claim 2, wherein the subtractive manufacturing equipment comprises a computer numerically controlled milling machine.

7. The method of claim 2, wherein the subtractive manufacturing equipment comprises a computer numerically controlled router.

8. The method of claim 2, further comprising:
revising data in the conforming site model file to provide for attachment points for model foliage; and
attaching model foliage to the site model.
